(19) United States
(12) Patent Application Publication
(10) Pub. No.: US 2025/0184022 A1
(43) Pub. Date: Jun. 5, 2025

(54) MACHINE LEARNING BASED GENERALIZED EQUIVALENT ISOTROPICALLY RADIATED POWER CONTROL

(71) Applicant: NOKIA SOLUTIONS AND NETWORKS OY, Espoo (FI)

(72) Inventors: Aliye KAYA, Murray Hill, NJ (US); Wolfgang Ulrich AICHMANN, Ulm (DE); Mahnaz SINAIE, Espoo (FI)

(21) Appl. No.: 18/845,156

(22) PCT Filed: Mar. 16, 2022
(86) PCT No.: PCT/US2022/020561

§ 371 Date: Sep. 9, 2024

(51) Int. Cl. H04B 17/391; H04B 17/10

(52) U.S. Cl. CPC H04B 17/3913; H04B 17/102

(57) ABSTRACT

Systems, methods, apparatuses, and computer program products for machine learning based generalized equivalent isotropically radiated power control are provided. For example, a method may include receiving a plurality of input parameters. The input parameters can describe a directional portion of a radiation pattern of an antenna array and a weighting to be applied to the antenna array. The method may further include processing the plurality of input parameters using a trained neural network. The method may also include providing an output representative of equivalent isotropically radiated power associated with the plurality of input parameters.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing machine learning based generalized equivalent isotropically radiated power control.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform receiving a plurality of input parameters. The input parameters can describe a directional portion of a radiation pattern of an antenna array and a weighting to be applied to the antenna array. The at least one memory and computer program code can also be configured, with the at least one processor, to cause the apparatus at least to perform processing the plurality of input parameters using a trained neural network. The at least one memory and computer program code can additionally be configured, with the at least one processor, to cause the apparatus at least to perform providing an output representative of equivalent isotropically radiated power associated with the plurality of input parameters.

An embodiment may be directed to an apparatus. The apparatus can include at least one processor and at least one memory comprising computer program code. The at least one memory and computer program code can be configured, with the at least one processor, to cause the apparatus at least to perform sending a plurality of input parameters to another processor configured with a trained neural network. The input parameters can describe a directional portion of a radiation pattern of an antenna array and a weighting to be applied to the antenna array. The at least one memory and computer program code can additionally be configured, with the at least one processor, to cause the apparatus at least to perform receiving, from the another processor, an output representative of equivalent isotropically radiated power associated with the plurality of input parameters. The at least one memory and computer program code can further be configured, with the at least one processor, to cause the apparatus at least to perform controlling the antenna array based on the output.

An embodiment may be directed to a method. The method may include receiving a plurality of input parameters. The input parameters can describe a directional portion of a radiation pattern of an antenna array and a weighting to be applied to the antenna array. The method may further include processing the plurality of input parameters using a trained neural network. The method may also include providing an output representative of equivalent isotropically radiated power associated with the plurality of input parameters.

An embodiment may be directed to a method. The method may include sending a plurality of input parameters to another processor configured with a trained neural network. The input parameters can describe a directional portion of a radiation pattern of an antenna array and a weighting to be applied to the antenna array. The method may additionally include receiving, from the another processor, an output representative of equivalent isotropically radiated power associated with the plurality of input parameters. The method may also include controlling the antenna array based on the output.

An embodiment may be directed to an apparatus. The apparatus may include means for receiving a plurality of input parameters. The input parameters can describe a directional portion of a radiation pattern of an antenna array and a weighting to be applied to the antenna array. The apparatus may additionally include means for processing the plurality of input parameters using a trained neural network. The apparatus may also include means for providing an output representative of equivalent isotropically radiated power associated with the plurality of input parameters.

An embodiment may be directed to an apparatus. The apparatus may include means for sending a plurality of input parameters. The input parameters can describe a directional portion of a radiation pattern of an antenna array and a weighting to be applied to the antenna array, to another processor configured with a trained neural network. The apparatus may additionally include means for receiving, from the another processor, an output representative of equivalent isotropically radiated power associated with the plurality of input parameters. The apparatus may also include means for controlling the antenna array based on the output.

### BRIEF DESCRIPTION OF THE DRAWINGS

For proper understanding of example embodiments, reference should be made to the accompanying drawings, wherein:

FIG. 1 illustrates an example design of an open radio unit;

FIG. 2 illustrates a pattern for a randomly chosen complex weight vector;

FIG. 3 illustrates a sample neural network;

FIG. 4 illustrates training steps that can be taken to train a neural network, according to certain embodiments;

FIG. 5 illustrates inference with a neural network, according to certain embodiments;

FIG. 6 illustrates data flow according to certain embodiments;

FIG. 7 illustrates prediction error in an example test of certain embodiments;

FIG. 8 illustrates a comparison of a ground truth and a machine learning estimate, according to certain embodiments;

FIG. 9 illustrates an example flow diagram of a method, according to an embodiment;

FIG. 10 illustrates an example flow diagram of a method, according to an embodiment; and

FIG. 11 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing machine learning based generalized equivalent isotropically radiated power control, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In many countries, regulators request monitoring of equivalent isotropically radiated power (EIRP) over time to guarantee that certain thresholds are not exceeded in any direction. Massive multiple-input/multiple-output (mMIMO) and beamforming, where the antenna gain is heavily increased in certain directions at the cost of other directions, have been introduced. The introduction of these technologies has led to the issue that a simple approach that only considers the maximum radiated power over the full sphere is no longer sufficient. Considering the maximum only, irrespective of the direction in which this power is radiated, and aggregating the maximum over time may result in permanent violation of the threshold. The target intended by EIRP control is, however, to limit the energy that is transmitted per angular segment over a certain time. Beamforming systems may change the direction of the beam main lobes frequently or permanently. Therefore, the regulation in some places has been enhanced such that EIRP is to be controlled per segment of solid angle and the thresholds can apply for any such segment. To fulfil the regulations, the beamforming system may need to monitor the radiated power and the direction in which the power is radiated. The beamforming system may then aggregate the radiated power per spatial segment.

In a mobile radio system, EIRP per segment of solid angle may be controlled. Such control may be a task of the instance that is scheduling the transmissions. Thus, for example, such control may not be in the radio unit itself, but in layer 1 or higher. The instance that schedules transmissions may have to calculate the power radiated into a certain direction. Such calculation may be straightforward as long as the antenna geometry and the complex radiation pattern of the single radiators are known. If, however, the O-RU unit is provided by a third-party vendor, the antenna details may not be shared by the O-RU vendor.

As mentioned above, the easiest way of EIRP control can be to multiply the pattern of the whole antenna array with the maximum beamforming gain without regarding the reduced power transmission in most of the directions. This leads, however, to an overestimation of transmitted power unless the same beamforming is always applied.

In the case of static beams, such as a grid-of-beams (GoB) based system, the EIRP per solid angle can be calculated offline and the results of this pre-calculation can be then applied at runtime. However, such offline calculation may be provided by third-party O-RU vendors and then provided to O-DU to control the EIRP.

In case of dynamic beamforming, such offline calculation may not be possible. Moreover, no current system provides highly accurate EIRP control for weight vectors that are calculated only at runtime, for example calculated by eigenvalue decomposition of the channel covariance matrix, known also as Eigen mode-based beamforming (EBB).

Certain embodiments can enable computation of EIRP per segment without requiring knowledge of the antenna details, such as the antenna geometry and the complex radiation pattern of the single radiators. Thus, certain embodiments may permit an open radio access network (O-RAN) where the O-RU and O-DU units are produced by different vendors. Based on certain embodiments, a third-party vendor can provide EIRP calculation as an xApp, which can be run in near real-time (RT) radio access network (RAN) intelligent controller (RIC) while keeping information about the antenna internal design and the related capabilities as their proprietary. In RIC, an xApp can refer to a software tool used to manage network functions in near-real time. Thus, a near-RT RIC can host multiple applications known as xApps.

Certain embodiments may also be used to compute the power density radiated in a specific direction even the full details of the radio unit are known to the network vendor, with much less computing effort, using a neural network.

The EIRP per segment may be a function of O-RU vendor specified parameters: antenna geometry, types of individual elements used in the array where each may have a different pattern, additional weighting, side-lobe suppression, connections to radiators, wiring, tapering, and the like. Almost all these parameters are vendor specific, and O-RU vendors may be unwilling to share all the O-RU antenna design parameters.

The EIRP per segment may also be a function of network vendor specified parameters: weight vector as computed by the algorithms running at gNB or O-DU, for example, Eigen beamforming weights, precoding weights, steering weights, interference suppression, power control, or the like.

Currently, the O-RU vendors only share the number of array elements, polarization of each array element and the distance between array elements. Any other information about the O-RU internal design and weight tables of the pre-stored beams in O-RU may not be shared with O-DU vendors. If the O-RU vendors provide beam patterns in horizontal and vertical direction in predefined beamforming configuration (i.e. GoB system), such information can be used for offline EIRP calculation, without revealing the design-specific parameters of O-RU. However, when the network vendor specified weights are applied, the beam pattern provided from the RU vendor may have no value in determining if EIRP limits are exceeded or not. Therefore, the EIRP per segment cannot be computed with the conventional data provided from the RU vendor unless the array pattern of each array element is shared.

Certain embodiments may provide a neural network for EIRP calculation per segment. Certain embodiments may enable the O-RU vendor to share the required information of a neural network or enable as a RAN service xApp application in near-real-time RIC to compute EIRP per segment without sharing any information about internal antenna design.

The O-RU vendor may be able to compute EIRP for any given dynamic weight vector w, since the O-RU can know all the parameters described above as O-RU vendor specified parameters. The O-RU vendor can train a neural network to learn the functionality of computing EIRP per segment for any given weight vector w.

The input to the neural network can be the weight vector w and the direction of antenna segment (θ, ϕ) where the EIRP is computed. As another option, the maximum EIRP can be computed for pre-defined segments. There may be some kind of segments that are represented by a single solid angle, pointing to the middle of the segment, a corner of the segment, or any other desired reference point. The EIRP value for the point may represent, for example, the actual value at the exact point, the average over the segment, the maximum within the respective segment, or the like. The output of the neural network can be the EIRP in that segment or any power related metric for that segment.

Training the neural network can be done by minimizing the difference between the correct EIRP and the EIRP as predicted by the neural network, given the input parameters w,θ,ϕ. The angles, θ,ϕ, could be restricted to specific angles, for example omitting angles at a back lobe.

The O-RU manufacturer may have at least two choices based on O-RAN architecture. In a first option, an O-RU vendor can share the parameters and the structure of the trained neural network with the network vendor. The structure of the neural network could be pre-agreed in standards like O-RAN. The neural network can be considered as a black box. Reverse engineering of black-box neural networks may not be straightforward, even if some attributes could be reverse engineered. It would be NP-hard to reverse engineer all parameters of internal O-RU antenna design from the neural network parameters.

A second option is that the O-RU shares this neural network as a RAN service xApp, which can be run in near-RT-RIC. The xApp can be an application designed to run on the Near-RT RIC. The xApp may include of one or more microservices and at the point of onboarding, the xApp can identify which data the xApp consumes and which data the xApp provides. The xApp can be independent of Near-RT RIC and can be provided by any O-RU vendor. Actual EIRP calculation can be done every sample. The data sampling can be on the granularity of changing weight vectors and time and frequency allocations (symbols and physical resource blocks (PRBs)) but the control loop can be on a larger time scale. Even if the update is done only once per 100 ms, the data sent to the instance evaluating the EIRP for the given period can receive each single record which was scheduled in DL during this time. Thus, certain embodiments may aggregate all transmitted energy per spatial segment. This can be performed by counting each single transmission with all relevant parameters: weight vectors applied, transmission power, and time and frequency allocation. The overall energy of the given time interval can thus be obtained. This granularity can be provided by a scheduler. The EIRP control instance can then execute the aggregation over a certain period in time, making use of the power distribution over spatial direction known via the neural network. The sampling rate is configurable from 100 ms to is. Consequently, if this neural network is provided by O-RU vendor as a RAN service xApp in near-RT RIC, for each sampling, the O-DU can send input parameters w,θ,ϕ to near-RT RIC via E2 link to calculate the EIRP. Using an xApp, the O-RU vendor does not need to share any information about the neural network with O-DU and can better protect the proprietary details of the design. In this scenario, even the output of xApp can be decided by O-RU. It can be as predicted EIRP or a binary value indicating if the EIRP for antenna segment (θ,ϕ) is exceeded when aggregated over all allocations that happened in the control period, when the O-RU vendor does not want to share the predicted EIRP.

The network vendor can use the neural network to determine the EIRP per segment of interest in run-time for any new weight vector.

The implementation of certain embodiments can follow a high-level process. In a first phase, the O-RU vendor can design the antenna product. In a second phase, the O-RU vendor can train the neural network to compute the EIRP at a given segment (θ,ϕ). In a third phase, the O-DU vendor can use the neural network to infer the EIRP at segment (θ,ϕ).

In the first phase, as mentioned above, the O-RU vendor can design the antenna product.

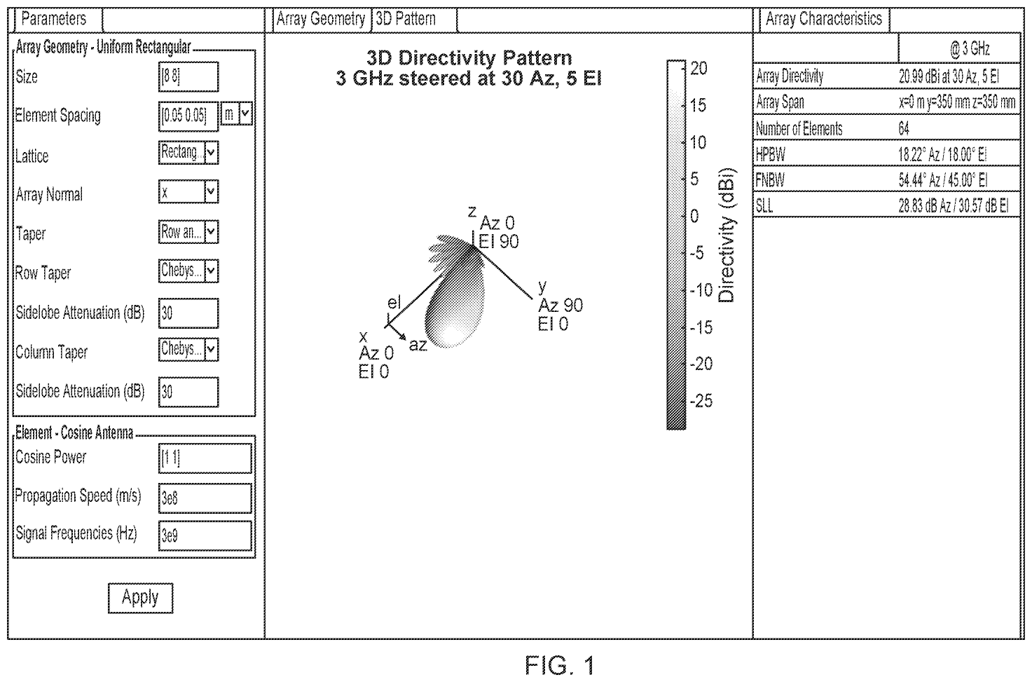

FIG. 1 illustrates an example design of an open radio unit. The design in FIG. 1 has been arbitrarily designed with one main lobe, and a number of side lobes. The parameters shown are merely an illustrative example, and are not limiting. In this example, there are 64 elements in the array, but any arbitrary number of elements can be included. For the purpose of this example, the O-RU vendor may have decided to reveal the number of antenna elements, but no further information about the array. The reason for revealing the number of antenna elements may be motivated by the relative ease of detecting the number of antenna elements through visual inspection, or any other reason.

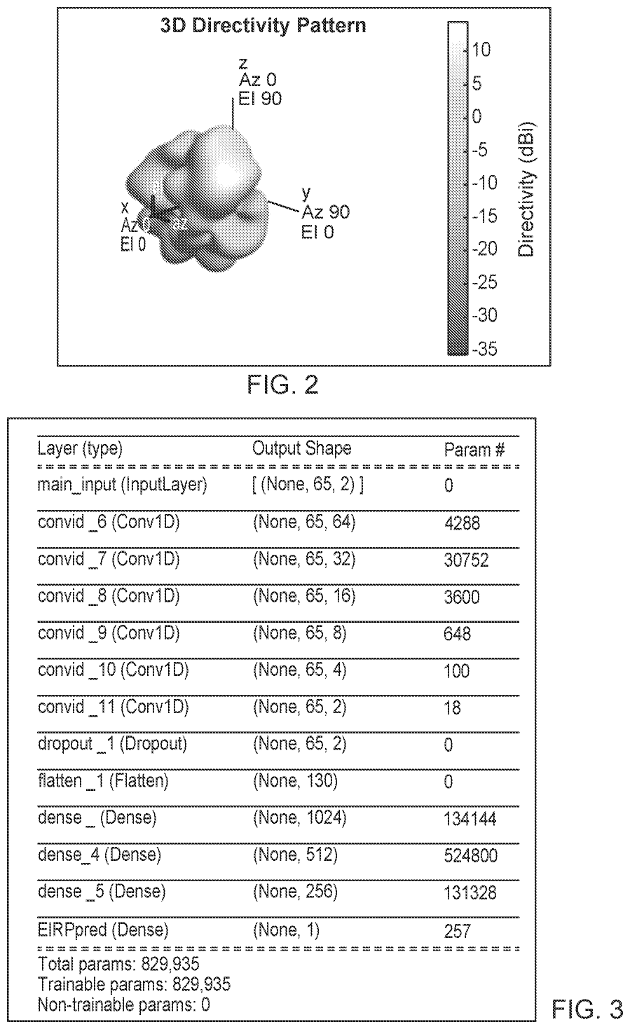

In a second phase, the O-RU vendor can train a neural network to compute the EIRP at an arbitrary segment defined by angles, (θ,ϕ). To train the neural network, the O-RU vendor can create training data that can include input parameters and an output parameter. The input parameters can include (θ,ϕ), which can respectively represent azimuth and elevation angle of the antenna segment of interest. The input parameters can also include w, which can be a complex weight vector. The values of w could be chosen randomly or selectively for training purposes. FIG. 2 shows a pattern for a randomly chosen complex weight vector. The weighting vector was randomly chosen in three dimensions. In practice, the actual weight vector may not be randomly selected, but random selection may be a useful option for training purposes for robustly training a neural network.

FIG. 3 illustrates a sample neural network. In the pre-processing steps, all of the input parameters can be combined to a single input. The real and imaginary parts of w can be mapped into a matrix U of size UϵR\hat{ }((|w|+1)×2). The last of column of the matrix can have the values (θ,ϕ). U can correspond to the main_input variable in the neural network structure in FIG. 3.

The output parameter of the neural network can be, for example, EIRP_(θ,ϕ,w), which can be the EIRP at spatial segment (θ,ϕ) if weight vector w is applied. The output could be a linear or dB value. EIRP_(θ,ϕ,w) values could be further quantized and rounded to zero for very small values. In the following. we have used floating point values. EIRP_(θ,ϕ,w) can correspond to the EIRP_pred output variable in FIG. 3.

As shown in FIG. 3, the neural network can include multiple layers. For example, multiple convolutional layers, a dropout layer, a flattening layer, and multiple dense layers can be included. In this example, the total number of parameters may be 829,935, of which 829,935 can be trainable parameters.

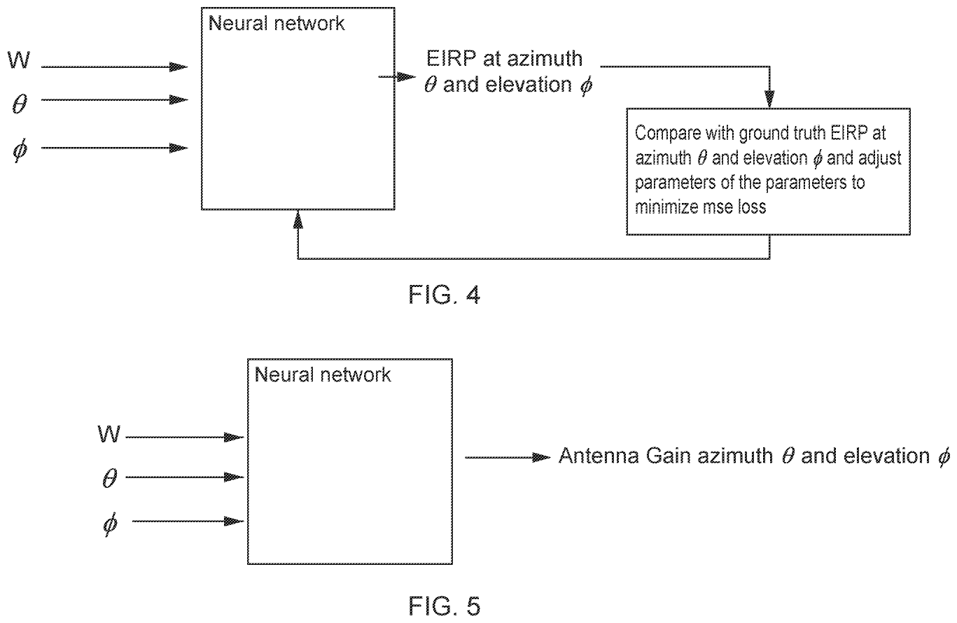

FIG. 4 illustrates training steps that can be taken to train a neural network, according to certain embodiments. Although the steps shown are one example, other sample neural nets than shown in FIG. 3 can be trained in a similar way, and other training approaches can be used than the approach illustrated in FIG. 4.

The training data can include batches of input data (w,θ,ϕ). For each input data sample, there can be a ground truth value EIRP_(θ,ϕ,w). The output of the neural network can be compared with the ground truth. The parameters of the neural network can be adjusted to minimize minimum square error or any other customized loss metric for every batch. Training can be stopped if the loss is reduced below a value. As this training can occur offline, it is not necessary to limit the training based on computational intensity or the like. On the other hand, training can be discontinued if there is any concern of overfitting.

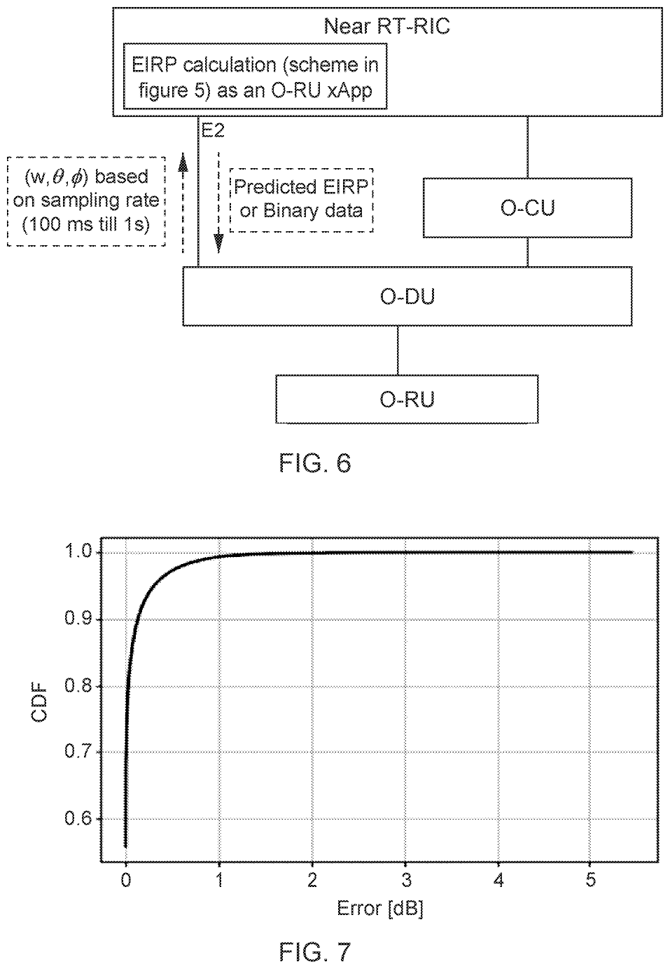

In a third phase, an O-DU vendor can use the neural network to infer the EIRP at segment (θ,ϕ). FIG. 5 illustrates inference with a neural network, according to certain embodiments. For any given weight vector, w, to be applied to the antenna panel, the O-DU vendor can run the neural network in inference mode and can determine EIRP at every θ and ϕ of interest. The network can output the antenna gain for the given azimuth and elevation.

The O-RU vendor can provide the trained neural network as an xApp that can be used by the O-DU to calculate the EIRP.

FIG. 6 illustrates data flow according to certain embodiments. FIG. 6 also illustrates a possible architecture to have an EIRP calculation as a RAN service use case for O-RAN. Each 100 ms for all allocated transmissions during the last 100 ms, the O-DU can send parameters w,θ,ϕ to near RT-RIC and the provided xApp from the O-RU vendor can calculate the EIRP per antenna segment. If xApp is to provide the aggregated EIRP, additionally the applied power as well as time and frequency allocations may have to be sent. However, for xApp, applied power, time and frequency allocations may not be sent because xApp may not be for EIRP controlling and may only be for EIRP measurement. After measurement, the results can be provided to layer 2 (L2). The L2 can, based on that calculated EIRP, decide how to control EIRP. Moreover, when using xApp, there may not be a need for one special machine learning model and the O-RU vendor may be free to use the O-RU vendor's own model and then provide the model to the O-DU vendor. Thus, instead of having embedded models, there can be an on top model by xApp and in both cases the input of the ML model may same with the place being different. The xApp may not need to know which physical resource block (PRB) has been allocated, but the xAPP may benefit from knowing how many PRBs have been allocated, in both frequency and time direction, to execute the aggregation. For some signals, not all resource elements (REs) per PRB are used. That difference can be handled by a respective scaling of the power. In any case, either the scheduler may collect such data over the measurement period or the scheduler may send the single transmission samples to the EIRP controller. Based on the O-RU xApp design, the output provided to O-DU can be the calculated EIRP or a binary value indicating whether the EIRP is higher than a threshold or not. The threshold can be configured by the O-RU vendor or may be reconfigurable by the O-DU vendor. The threshold may be a parameter controllable by the operator and the threshold may have different values for different directions. For example, there may be different thresholds in a direction of an airport, a hospital, or a school, than in a typical direction. Likewise, the threshold may be different in a direction where human beings are expected to be stationary, as opposed to the sky, where human beings are expected to be generally absent and usually at high speed when present.

The neural network of FIG. 3 was evaluated. For training set, random weight vectors and vectors with a predetermined direction were selected in 10-degree steps both in elevation and azimuth. The input was a reference to a weight vector, which was unique and could be resolved by the neural network. In this example, some predetermined vectors were used, but such usage is not necessary. For testing, new weight vectors not used in training were created. FIG. 7 illustrates prediction error in an example test of certain embodiments. The trained network was able to calculate the EIRP within 1-dB for every direction of interest where EIRP is above 10 dB. That error was within 0.25 dB for locations with EIRP above 20 dB. Such a level of error may be considered feasible.

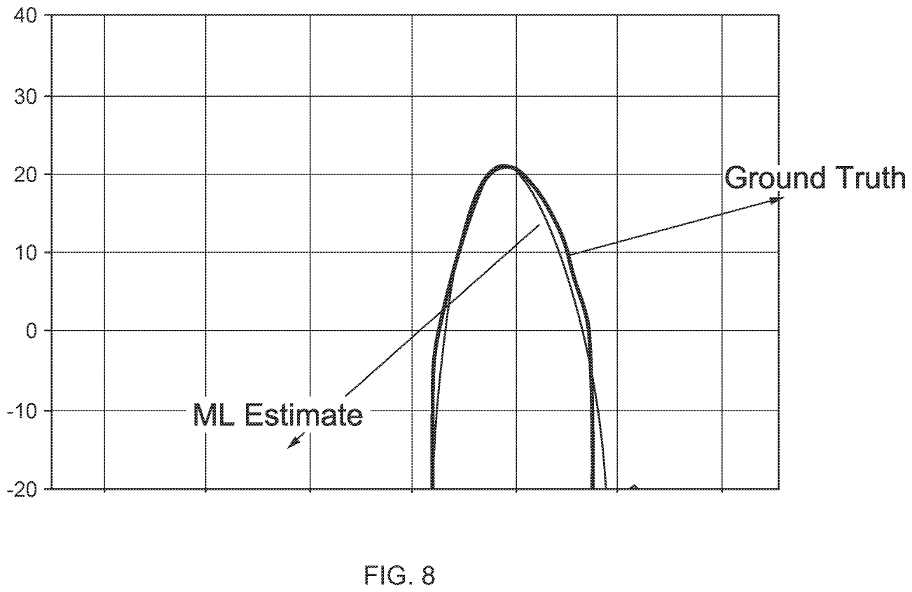

FIG. 8 illustrates a comparison of a ground truth and a machine learning estimate, according to certain embodiments. More specifically, FIG. 8 provides a comparison of a real EIRP, the ground truth, with a machine learning (ML) estimate. As can be seen from FIG. 8, the ML estimate is a close approximation of the real EIRP.

The approach described above may be used for static beams and may eliminate the complexity of computing EIRP analytically from antenna gain patterns that are saved in configuration files. Moreover, this approach may avoid the need to save several hundred static beam patterns for EIRP calculation purposes. The approach described above may be generalized to other applications. For example, the approach described above can be used in any application where computation of EIRP is needed either in run-time or for a large number of static beams. The use cases case are not limited to O-RAN, although O-RAN is a possible implementation.

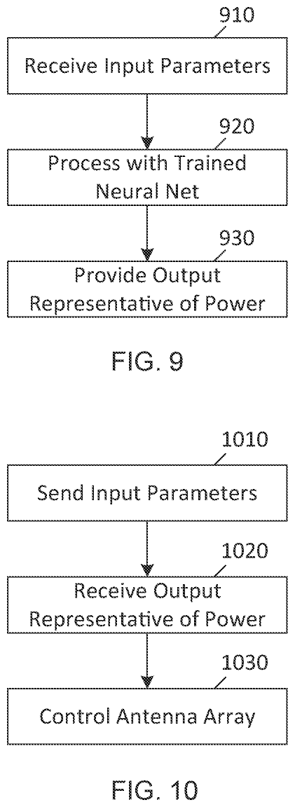

FIG. 9 illustrates an example flow diagram of a method for providing machine learning based generalized equivalent isotropically radiated power control, according to certain embodiments.

The method can include, at 910, receiving a plurality of input parameters. The input parameters can describe a directional or volumetric portion of a radiation pattern of an antenna array and a weighting to be applied to the antenna array. For example, the directional portion may be a segment or sector. The plurality of input parameters can describe the directional portion by a first angle representative of an azimuth, represented by the Greek letter theta above, and by a second angle representative of an elevation, represented by the Greek letter phi above. The weighting can be a three-dimensional weighting using a complex weight vector, such as w, discussed above. The resulting beam pattern can be three-dimensional. The weights themselves, however, may describe a two-dimensional array although, in principal, the array could also be three-dimensional.

The method can also include, at 920, processing the plurality of input parameters using a trained neural network. The plurality of input parameters can be provided to the trained neural network as a single input in matrix form, such as U, described above. The trained neural network may have the various inputs, output, and layers illustrated in FIG. 3. Any other desired trained neural network can be substituted.

The method can further include, at 930, providing an output representative of equivalent isotropically radiated power associated with the plurality of input parameters. The output can include a value of equivalent isotropically radiated power associated with the plurality of input parameters. For example, the actual value of the power can be output. As another option, the processing at 920 can include comparing the equivalent isotropically radiated power associated with the plurality of input parameters to a threshold. The providing the output at 930 can include providing a binary indication indicative of a result of the comparing, such as whether the power exceeds a safety threshold, exposure threshold, or any other desired threshold.

The processing at 930 can include performing a calculation of the equivalent isotropically radiated power associated with the plurality of input parameters once per sample. The sample rate of the sample can be configurable from 100 ms to 1 s per sample. These values should be understood as approximate with one significant digit. Other ranges of sample rates can also be used. the input has to cover each single transmission with time and frequency allocation, applied power and applied weight vector.

It is noted that FIG. 9 is provided as one example embodiment of a method or process. However, certain embodiments are not limited to this example, and further examples are possible as discussed elsewhere herein.

FIG. 10 illustrates an example flow diagram of a method for providing machine learning based generalized equivalent isotropically radiated power control, according to certain embodiments. The method of FIG. 10 can be used alone or in combination with the method of FIG. 9. The methods of FIGS. 9 and 10 can be implemented by a data flow such as shown in FIG. 6.

The method of FIG. 10 may include, at 1010, sending a plurality of input parameters. The input parameters can describe a directional or volumetric portion of a radiation pattern of an antenna array and a weighting to be applied to the antenna array, to another processor configured with a trained neural network. These can be the same parameters received at 910 above.

The method can also include, at 1020, receiving, from the other processor, an output representative of equivalent isotropically radiated power associated with the plurality of input parameters.

The method can further include, at 1030, controlling the antenna array based on the output. For example, if the output would exceed a threshold, the use of the weight may be rejected and a new weight may be proposed.

The input parameters, weighting, and output can be as described above with reference to FIG. 9.

Thus, for example, the other processor can compare the equivalent isotropically radiated power associated with the plurality of input parameters to a threshold. In such a case, the receiving the output can include receiving a binary indication indicative of a result of the comparing.

Likewise, the sending the plurality of input parameters and receiving the output can be performed once per sample. The sample rate of the sample is configurable from 100 ms to 1 s per sample.

It is noted that FIG. 10 is provided as one example embodiment of a method or process. However, certain embodiments are not limited to this example, and further examples are possible as discussed elsewhere herein.

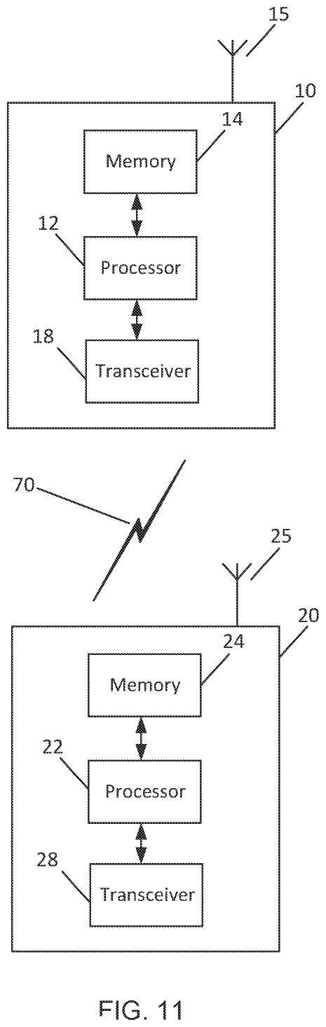

FIG. 11 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 11.

As illustrated in the example of FIG. 11, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 3-10, or any other method described herein. In some embodiments, as discussed herein, apparatus 10 may be configured to perform a procedure relating to providing machine learning based generalized equivalent isotropically radiated power control, for example.

FIG. 11 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 11.

As illustrated in the example of FIG. 11, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 3-10, or any other method described herein. For example, in an embodiment, apparatus 20 may be controlled to perform a process relating to providing machine learning based generalized equivalent isotropically radiated power control, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may provide a neural network for EIRP calculation per segment. Certain embodiments may enable the O-RU vendor to share the required information of a neural network or enable as a RAN service xApp application in near-real-time RIC to compute EIRP per segment without sharing any information about internal antenna design.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

EBB Eigen mode-Based Beamforming
EIRP Effective Isotropic Radiated Power
GoB Grid-of-Beam
O-RAN Open Radio Access Network
O-RU Open Radio Unit
O-DU Open Distributed Unit
Near RT-RIC Near Real-Time RAN Integrated Controller
RAN Radio Access Network
RIC RAN Intelligent Controller

1. An apparatus, comprising:
at least one processor; and
at least one memory comprising computer program instructions,
wherein the at least one memory and the computer program instructions are configured to, with the at least one processor, cause the apparatus at least to perform:
receiving a plurality of input parameters, wherein the input parameters describe a directional portion of a radiation pattern of an antenna array and a weighting to be applied to the antenna array;
processing the plurality of input parameters using a trained neural network; and
providing an output representative of equivalent isotropically radiated power associated with the plurality of input parameters.

2. The apparatus of claim 1, wherein the plurality of input parameters describe the directional portion by a first angle representative of an azimuth and by a second angle representative of an elevation.

3. The apparatus of claim 1, wherein the weighting comprises a three-dimensional weighting using a complex weight vector.

4. The apparatus of claim 1, wherein the plurality of input parameters are provided to the trained neural network as a single input in matrix form.

5. The apparatus of claim 1, wherein the output comprises a value of equivalent isotropically radiated power associated with the plurality of input parameters.

6. The apparatus of claim 1, wherein the processing comprises comparing the equivalent isotropically radiated power associated with the plurality of input parameters to a threshold, wherein the providing output comprises providing a binary indication indicative of a result of the comparing.

7. The apparatus of claim 1, wherein the processing comprises performing a calculation of the equivalent isotropically radiated power associated with the plurality of input parameters once per sample.

8. The apparatus of claim 7, wherein a sample rate of the sample is configurable from 100 ms to 1 s per sample.

9. An apparatus, comprising:
at least one processor; and
at least one memory comprising computer program instructions,
wherein the at least one memory and the computer program instructions are configured to, with the at least one processor, cause the apparatus at least to perform:
sending a plurality of input parameters, wherein the input parameters describe a directional portion of a radiation pattern of an antenna array and a weighting to be applied to the antenna array, to another processor configured with a trained neural network;
receiving, from the another processor, an output representative of equivalent isotropically radiated power associated with the plurality of input parameters; and
controlling the antenna array based on the output.

10. The apparatus of claim 9, wherein the plurality of input parameters describe the directional portion by a first angle representative of an azimuth and by a second angle representative of an elevation.

11. The apparatus of claim 9, wherein the weighting comprises a three-dimensional weighting using a complex weight vector.

12. The apparatus of claim 9, wherein the plurality of input parameters are provided to the trained neural network as a single input in matrix form.

13. The apparatus of claim 9, wherein the output comprises a value of equivalent isotropically radiated power associated with the plurality of input parameters.

14. The apparatus of claim 9, wherein the another processor compares the equivalent isotropically radiated power associated with the plurality of input parameters to a threshold, wherein the receiving the output comprises receiving a binary indication indicative of a result of the comparing.

15. The apparatus of claim 9, wherein the sending the plurality of input parameters and the receiving the output is performed once per sample.

16. The apparatus of claim 15, wherein a sample rate of the sample is configurable from 100 ms to 1 s per sample.

17. A method, comprising:
receiving a plurality of input parameters, wherein the input parameters describe a directional portion of a radiation pattern of an antenna array and a weighting to be applied to the antenna array;
processing the plurality of input parameters using a trained neural network; and
providing an output representative of equivalent isotropically radiated power associated with the plurality of input parameters.

18. The method of claim 17, wherein the plurality of input parameters describe the directional portion by a first angle representative of an azimuth and by a second angle representative of an elevation.

19. The method of claim 17, wherein the weighting comprises a three-dimensional weighting using a complex weight vector.

20. The method of claim 17, wherein the plurality of input parameters are provided to the trained neural network as a single input in matrix form.

21.-48. (canceled)
